(19) United States
(12) Patent Application Publication
(10) Pub. No.: US 2024/0063637 A1
(43) Pub. Date: Feb. 22, 2024

(54) GRID SUPPLY LOAD PREDICTING METHOD, SYSTEM USING THE SAME, AND STORAGE MEDIUM

(71) Applicant: Guangxi University, Nanning (CN)

(72) Inventors: Biyun CHEN, Nanning (CN); Qi XU, Nanning (CN); Bin LI, Nanning (CN); Xiaoqing BAI, Nanning (CN); Yun ZHU, Nanning (CN); Peijie LI, Nanning (CN); Chi ZHANG, Nanning (CN); Yude YANG, Nanning (CN); Hua WEI, Nanning (CN)

(21) Appl. No.: 17/890,278

(22) Filed: Aug. 18, 2022

(51) Int. Cl. H02J 3/00; G06Q 10/06; G06Q 50/06

(52) U.S. Cl. CPC H02J 3/003; H02J 3/004; G06Q 10/0633; G06Q 50/06; H02J 2203/10

(57) ABSTRACT

The present disclosure discloses a grid supply load predicting method, a system, and a storage medium. The method includes: determining a characteristic historical data set of a grid supply load; obtaining a grid supply load characteristic trend prediction result by inputting the characteristic data set of the historical grid supply load and the daily characteristic data of target influencing factor into a preset trend prediction model for grid supply load characteristic trend prediction; determining a grid supply load curve type; obtaining a grid supply load prediction model corresponding to the grid supply load curve type to take as a target prediction model; and obtaining a target grid supply load prediction result by inputting the historical data set of the grid supply load, the grid supply load characteristic trend prediction result and the daily characteristic data of target influencing factor into the target prediction model for grid supply load prediction.

### BACKGROUND

### 1. Technical Field

The present disclosure relates to artificial intelligence technology, and particularly to a grid supply load predicting method, a system using the same, and a storage medium.

### 2. Description of Related Art

In the power industry, grid supply load includes local power consumption and local power generation. In the areas with abundant water resources, the local power generation is mainly provided by the small hydropower stations. But with the continuous increment of the connected small hydropower stations, how to accurately predict the grid supply load in the areas with many small hydropower stations, has become a key issue in this industry. Due to the grid supply load having multi-frequency periodicity of electricity consumption load and the random fluctuation characteristic of the power generation of small hydropower stations, the grid supply load has dual uncertainty of source and load. However, when a mathematical statistical predicting model is used to predict, because the mathematical statistical predicting model cannot handle relatively complex nonlinear load data, the random fluctuation characteristic of the generation load of the small hydropower stations cannot be reflected; and when a single artificial intelligence algorithm is used to predict, because there are many input data, low prediction precision will be caused. In addition, the existing prediction methods do not comprehensively consider the influence of the dual uncertainty of source and load on the grid supply load, low prediction accuracy of the grid supply load will be caused.

### SUMMARY

The purpose of the present disclosure is to provide a grid supply load prediction method, a system using the same, and a storage medium for the above-mentioned problems.

A grid supply load predicting method for a target electrical grid is provided. The method may include:
obtaining a target prediction day and a historical data set of a grid supply load of the target electrical grid and daily characteristic data of target influencing factor corresponding to the target prediction day, and determining a characteristic data set of a historical grid supply load based on the historical data set of the grid supply load;
obtaining a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
determining a grid supply load curve type corresponding to the target prediction day based on the grid supply load characteristic trend prediction result and the daily characteristic data of target influencing factor;
obtaining a grid supply load prediction model corresponding to the grid supply load curve type to take as a target prediction model; and
obtaining a target grid supply load prediction result that corresponds to the target prediction day by inputting the historical data set of the grid supply load, the grid supply load characteristic trend prediction result and the daily characteristic data of target influencing factor into the target prediction model for grid supply load prediction.

A grid supply load predicting system for a target electrical grid is provided. The system may include:
a data obtaining module configured to obtain a target prediction day and a historical data set of a grid supply load of the target electrical grid and daily characteristic data of target influencing factor corresponding to the target prediction day, and determine a characteristic data set of a historical grid supply load based on the historical data set of the grid supply load;
a grid supply load characteristic trend predicting module configured to obtain a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
a grid supply load curve type determining module configured to determine a grid supply load curve type corresponding to the target prediction day based on the grid supply load characteristic trend prediction result and the daily characteristic data of target influencing factor;
a target prediction model determining module configured to obtain a grid supply load prediction model corresponding to the grid supply load curve type to take as a target prediction model; and
a target grid supply load predicting module configured to obtain a target grid supply load prediction result that corresponds to the target prediction day by inputting the historical data set of the grid supply load, the grid supply load characteristic trend prediction result and the daily characteristic data of target influencing factor into the target prediction model for grid supply load prediction.

A non-transitory computer-readable storage medium stored with at least a computer program is provided. The computer program may include:
instructions for obtaining a target prediction day and a historical data set of a grid supply load of the target electrical grid and daily characteristic data of target influencing factor corresponding to the target prediction day, and determining a characteristic data set of a historical grid supply load based on the historical data set of the grid supply load;
instructions for obtaining a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
instructions for determining a grid supply load curve type corresponding to the target prediction day based on the grid supply load characteristic trend prediction result and the daily characteristic data of target influencing factor;
instructions for obtaining a grid supply load prediction model corresponding to the grid supply load curve type to take as a target prediction model; and
instructions for obtaining a target grid supply load prediction result that corresponds to the target prediction day by inputting the historical data set of the grid supply load, the grid supply load characteristic trend prediction result and the daily characteristic data of target influencing factor into the target prediction model for grid supply load prediction.

The above-mentioned method of the present disclosure realizes the extraction of characteristic indexes and the optimization of the original data set using multiple prediction algorithms by predicting the grid supply load characteristic trend, determining the grid supply load curve type, and predicting the grid supply load based on the characteristic data set of the historical grid supply load and the daily characteristic data of target influencing factor, and further realizes the prediction of grid supply load based on the integration of predicting the grid supply load characteristic trend, determining the grid supply load curve type, and predicting the grid supply load, according to the historical data set of the grid supply load, the grid supply load characteristic trend prediction result, the daily characteristic data of target influencing factor, and the grid supply load curve type. Since coupling relationship between the power consumption and the power generation is fully explored, the precision and the accuracy of the prediction of the grid supply load are effectively improved.

### BRIEF DESCRIPTION OF THE DRAWINGS

To describe the technical schemes in the embodiments of the present disclosure or the prior art more clearly, the following briefly introduces the drawings required for describing the embodiments or the prior art. It should be understood that the drawings in the following description merely show some embodiments. For those skilled in the art, other drawings can be obtained according to the drawings without creative efforts.

FIG. 1 is a flow chart of a grid supply load predicting method according to an embodiment of the present disclosure.

FIG. 2 is a schematic block diagram of the structure of a grid supply load predicting system according to an embodiment of the present disclosure.

FIG. 3 is a schematic block diagram of the structure of a computing device according to an embodiment of the present disclosure.

### DETAILED DESCRIPTION

The technical solutions in the embodiments of the present disclosure will be clearly and completely described below with reference to the drawings. Apparently, the described embodiments are part of the embodiments of the present disclosure, but not all of the embodiments. All other embodiments obtained by those skilled in the art based on the embodiments of the present disclosure without creative efforts are within the scope of the present disclosure.

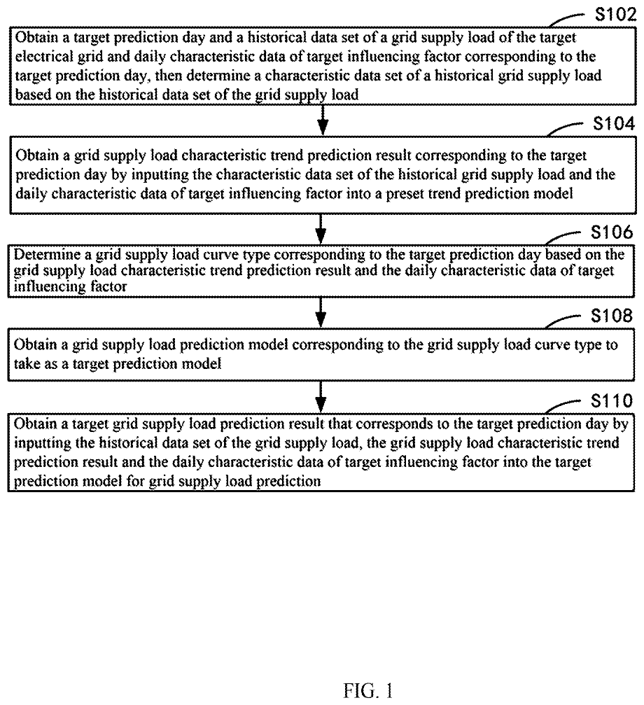

FIG. 1 is a flow chart of a grid supply load predicting method according to an embodiment of the present disclosure. As shown in FIG. 1, in one embodiment, a grid supply load predicting method for a target electrical grid is provided. The method may be applied to a terminal device or a server. In this embodiment, the application on the terminal is taken as an example. The method may include the following steps.

102: obtaining a target prediction day and a historical data set of a grid supply load of the target electrical grid and daily characteristic data of target influencing factor corresponding to the target prediction day, then determining a characteristic data set of a historical grid supply load based on the historical data set of the grid supply load.

The target prediction day is the date to predict grid supply load.

The historical data set of the grid supply load and the daily characteristic data of target influencing factor that correspond to the target prediction day refer to the historical data set of the grid supply load and the daily characteristic data of target influencing factor that correspond to the target prediction day. That is, the historical data set of the grid supply load is the detection data of a grid supply load of the target electrical grid within a preset number of days before the target prediction day, and the daily characteristic data of target influencing factor is the characteristic data of the factors affecting the prediction of grid supply load on the target prediction day.

The historical data set of the grid supply load includes a plurality of historical grid supply load data. The historical grid supply load data may include detection date, time point, and a detection value of grid supply load at a single time point. That is, the historical data set of the grid supply load is sequence data sorted by the detection date and the time point. Each day is divided into multiple time points at preset time intervals, for example, every 15 minutes may be a time point. The detection value of grid supply load at the single time point is the detection value of the grid supply load at a certain time point. The detection value of the grid supply load is the actual value of the local power consumption minus that of the local power generation. The local power consumption is the power consumption of the area corresponding to the historical data set of the grid supply load. The local power generation is the power generation in the area corresponding to the historical data set of the grid supply load.

The daily characteristic data of target influencing factor is the daily characteristic data of the influencing factors in the target prediction day. The daily characteristic data of the influencing factors may include time points and a factor feature set. That is, the daily characteristic data of the influencing factors is sequence data sorted by time point. The factor feature set may include a plurality of factor features. The factor features may include temperature features, weather type features, rainfall features and day type features. The temperature features are a kind of features extracted according to the outdoor temperature. The weather type features are a kind of features extracted according to the weather type. The rainfall features are a kind of features extracted according to the rainfall. The day type features are a kind of features extracted according to the type of day. The day type has only one value which may be working day, weekend, or legal holiday.

As an example, it may obtain what input by the user including the target prediction day, and the historical data set of the grid supply load and the daily characteristic data of target influencing factor that correspond to the target prediction day; it may also obtain, from a database, the target prediction day, and the historical data set of the grid supply load and the daily characteristic data of target influencing factor that correspond to the target prediction day, or it may further obtain, from a third-party application, the target prediction day, and the historical data set of the grid supply load and the daily characteristic data of target influencing factor that correspond to the target prediction day. The characteristic data set of the historical grid supply load may be obtained by extracting the average value of grid supply load, the peak value of grid supply load, and the valley value of grid supply load at each day from the detection value of grid supply load of each time point in the historical data set of the grid supply load.

The characteristic data set of the historical grid supply load may include detection dates, average values of grid supply load, peak values of grid supply load, and valley values of grid supply load. That is, the characteristic data set of the historical grid supply load is sequence data sorted by the detection date.

104: obtaining a grid supply load characteristic trend prediction result corresponding to the target prediction day by inputting the characteristic data set of the historical grid supply load and the daily characteristic data of target influencing factor into a preset trend prediction model.

The grid supply load characteristic trend prediction result may include the prediction result of the average value of grid supply load, the prediction result of the peak value of grid supply load, and the prediction result of the valley value of grid supply load.

As an example, the daily comprehensive characteristic of each factor feature in the daily characteristic data of target influencing factor may be extracted by day, and each extracted daily comprehensive characteristic may be used as an influencing factor daily summary characteristic data. A prediction sequence of grid supply load characteristics may be obtained by inputting the characteristic data set of the historical grid supply load and the influencing factor daily summary characteristic data into the preset trend prediction model for grid supply load characteristic trend prediction, and the data of the target prediction day may be extracted from the prediction sequence of grid supply load characteristic to use as the grid supply load characteristic trend prediction result corresponding to the target prediction day. In this way, the three values (i.e., the average value of grid supply load, the peak value of grid supply load, and the valley value of grid supply load) of the target prediction day can be predicted based on the characteristic data set of the historical grid supply load that is days, so as to provide a basis for the prediction of grid supply load curve type.

It should be noted that the data input into the trend prediction model does not include historical influencing factor daily characteristic data, so as to avoid the dimension of the data input into the trend prediction model being too long and leading to overfitting. The overfitting will lead to a decrease in the accuracy of the prediction.

In which, the extraction of the daily comprehensive characteristic is performed on each factor feature in the daily characteristic data of target influencing factor by day, and at least one of the average value, the maximum value and the minimum value may be extracted. For example, the average value of each value corresponding to the temperature features in the daily characteristic data of target influencing factor may be extracted, and the extracted average value may be used as the daily comprehensive characteristic corresponding to the temperature features.

In which, the trend prediction model may be a model trained based on a Long Short-term Memory (LSTM) neural network.

Since the characteristic data set of the historical grid supply load is a three-value data sequence (i.e., a data sequence of the above-mentioned three values) in date order that is obtained according to the detection value of the historical grid supply load at the single time point, its three values already reflect the comprehensive result of various influencing factors of historical daily characteristics. Therefore, in the present disclosure, the characteristic data set of the historical grid supply load and the daily characteristic data of target influencing factor corresponding to the target prediction day are input into the preset trend prediction model for grid supply load characteristic trend prediction, thereby obtaining the grid supply load characteristic trend prediction result corresponding to the target prediction day while reducing the amount of data processing, preventing overfitting, and improving the accuracy.

106: determining a grid supply load curve type corresponding to the target prediction day based on the grid supply load characteristic trend prediction result and the daily characteristic data of target influencing factor.

As an example, a classification prediction is performed on a grid supply load daily curve corresponding to the grid supply load characteristic trend prediction result based on the grid supply load characteristic trend prediction result and the daily characteristic data of target influencing factor so as to use the classification label of the classification prediction as the grid supply load curve type corresponding to the target prediction day, thereby determining the grid supply load curve type corresponding to the target prediction day by comprehensively considering the three values and external influence factors (i.e., the daily characteristic data of target influencing factor) of the target prediction day. In comparison with the existing similar day selection algorithm which determines the grid supply load curve type, it can select the grid supply load curve type that meets the trend of grid supply load and the external influence factors of the target prediction day simultaneously by comprehensively considering the three values and the external influence factors of the target prediction day, thereby improving the accuracy of the determined grid supply load curve type.

That is, the grid supply load curve type is the category of the grid supply load daily curve.

108: obtaining a grid supply load prediction model corresponding to the grid supply load curve type to take as a target prediction model.

As an example, the grid supply load prediction model corresponding to the grid supply load curve type may be obtained from a database or a third-party application. The obtained grid supply load prediction model corresponding to the grid supply load curve type may be used as the target prediction model.

The grid supply load prediction model is a model for predicting grid supply load. A model that can process long inputs may be selected as the grid supply load prediction model because the model can improve the prediction effect.

In one embodiment, the grid supply load prediction model may be a model obtained by training based on a temporal convolutional network (TCN). It is beneficial to the improvement of the predicting effect of the grid supply load prediction model because the temporal convolutional network is a model that can process long-term series input.

110: obtaining a target grid supply load prediction result that corresponds to the target prediction day by inputting the historical data set of the grid supply load, the grid supply load characteristic trend prediction result and the daily characteristic data of target influencing factor into the target prediction model for grid supply load prediction.

As an example, part or all of the data in the historical data set of the grid supply load, the grid supply load characteristic trend prediction result and the daily characteristic data of target influencing factor may be input into the target prediction model for grid supply load prediction, and each predicted value of the grid supply load may be used as the target grid supply load prediction result corresponding to the target prediction day.

The target grid supply load prediction result may include time points and prediction values of grid supply load. The predicted value of grid supply load is a net load value obtained by subtracting the power generation from the power consumption.

In one embodiment, the value corresponding to the day type features in the daily characteristic data of target influencing factor may be deleted to obtain the processed daily characteristic data of target influencing factor. Part or all of the data in the historical data set of the grid supply load, the grid supply load characteristic trend prediction result and the processed daily characteristic data of target influencing factor may be input into the target prediction model for grid supply load prediction so as to obtain the target grid supply load prediction result corresponding to the target prediction day.

That is, when predicting grid supply load, the data corresponding to the day type features may be selectively used, since the use of the data corresponding to the day type features has little effect on the prediction accuracy.

It should be noted that the data input into the target prediction model does not include the historical influencing factor daily characteristic data, so as to avoid the dimension of the data input into the target prediction model being too long and leading to overfitting. The overfitting will lead to a decrease in the accuracy of the prediction.

It should be noted that in this embodiment, through inputting the target prediction day and the historical data set of the grid supply load and the daily characteristic data of target influencing factor that correspond to the target prediction day, the target grid supply load prediction result corresponding to the target prediction day can be determined immediately, and the automation degree of prediction is improved. In comparison with the existing method that inputs the data for predicting one time point at a time, in this method, the target grid supply load prediction result includes the predicted value of grid supply load of all time points on the target prediction day, thereby inputting the data for predicting multiple time point at a time and therefore improves the efficiency of prediction.

It should be noted that the predictions of the grid supply load characteristic trend and the grid supply load curve type are both primary predictions. By selecting the grid supply load prediction model using the primary predictions, the output of the prediction of grid supply load is limited so as to avoid the out-of-scope data from appearing in the target grid supply load prediction result, thereby improving the accuracy of the determined target grid supply load prediction result.

It should be noted that the prediction of the grid supply load characteristic trend and that of the grid supply load curve type are aimed at long-term inherent trend characteristics of grid supply load. In the present disclosure, by analyzing the long-term trend (i.e., the historical data set of the grid supply load) and the short-term trend (i.e., the daily characteristic data of target influencing factor) of grid supply load while combing with the result of long-term trend prediction (i.e., the grid supply load curve type and the grid supply load characteristic trend prediction result) and real-time refined meteorological data (i.e., the daily characteristic data of target influencing factor), which improves the accuracy of the target grid supply load prediction result.

In this method, it realizes the extraction of characteristic indexes and the optimization of the original data set using multiple prediction algorithms by predicting the grid supply load characteristic trend, determining the grid supply load curve type, and predicting the grid supply load based on the characteristic data set of the historical grid supply load and the daily characteristic data of target influencing factor, and further realizes the prediction of grid supply load based on the integration of the prediction of the grid supply load characteristic trend, the determination of the grid supply load curve type, and the prediction of the grid supply load, according to the historical data set of the grid supply load, the grid supply load characteristic trend prediction result, the daily characteristic data of target influencing factor, and the grid supply load curve type. The coupling relationship between the power consumption and the power generation is fully explored, and the precision and the accuracy of the prediction of the grid supply load are effectively improved.

In one embodiment, the above-mentioned step (106) of determining the grid supply load curve type corresponding to the target prediction day based on the grid supply load characteristic trend prediction result and the daily characteristic data of target influencing factor may include the following steps.

202: obtaining the grid supply load curve type corresponding to the target prediction day by inputting the grid supply load characteristic trend prediction result and the daily characteristic data of target influencing factor into a preset curve classification model for classification prediction of the grid supply load daily curve.

As an example, the grid supply load characteristic trend prediction result and the daily characteristic data of target influencing factor may be input into the preset curve classification model to perform classification prediction of the grid supply load daily curve, and the data obtained by the classification prediction is used as a classification prediction vector. The vector element with the largest value is searched from the classification prediction vector so as to use the searched value as a hit vector element. The class corresponding to the hit vector element is used as the grid supply load curve type corresponding to the target prediction day.

The curve classification model may be a model obtained by training based on a support-vector machine (SVM).

In this embodiment, the curve classification model is used for classification prediction. The prediction through the network model is beneficial to the improvement of the prediction accuracy. The data input to the curve classification model does not include the historical influencing factor daily characteristic data, so as to avoid the dimension of the data input into the curve classification model being too long which leading to overfitting. The overfitting will lead to a decrease in the accuracy of the prediction.

In one embodiment, before the above-mentioned step (202) of obtaining the grid supply load curve type corresponding to the target prediction day by inputting the grid supply load characteristic trend prediction result and the daily characteristic data of target influencing factor into a preset curve classification model for classification prediction of the grid supply load daily curve, the method may further include the following steps.

302: obtaining a sample data set of the historical grid supply load;

As an example, it may obtain the sample data set of the historical grid supply load that is input by the user; and it may also obtain the sample data set of the historical grid supply load from a database or a third-party application.

The sample data set of the historical grid supply load may include a plurality of sample data of single-day grid supply load. The sample data of single-day grid supply load may include a detection date, time points, and a detection value of grid supply load at a single time point.

304: obtaining a plurality of target cluster sets by clustering each sample data of single-day grid supply load in the sample data set of the historical grid supply load;

As an example, a preset clustering algorithm may be used to cluster each sample data of single-day grid supply load in the sample data set of the historical grid supply load, then each clustered cluster set may be used as one target cluster set.

The preset clustering algorithms may include a K-means clustering algorithm.

306: generating a first training sample set base on each of the target cluster sets and an influencing factor daily characteristic data sample set corresponding to the sample data set of the historical grid supply load; The first training sample set may include a plurality of first training samples. The first training sample is in one-to-one correspondence with the sample data of single-day grid supply load in the sample data set of the historical grid supply load. The first training sample may include a single-day sample data and a class calibration value. The class calibration value is a vector. Each vector element in the class calibration value corresponds to a class. When the value of the vector element of the class calibration value is 1, the class corresponding to the vector element whose value is 1 is used as the curve type corresponding to the single-day sample data.

As an example, the single-day sample data may be extracted according to each sample data of a single-day grid supply load in the sample data set of the historical grid supply load, and the class calibration value may be determined according to the target cluster set that the sample data of single-day grid supply load belongs to, so that there is no need to manually mark the class calibration value.

308: sampling the first training sample set to train a preset initial curve classification model, and taking the trained initial curve classification model as the curve classification model.

The step for sampling the first training sample set to train the preset initial curve classification model will not be repeated herein.

When the loss value of the initial curve classification model converges to a preset first value, it may be determined that the training of the initial curve classification model is completed. The initial curve classification model after training is a model that achieves the expected training target. Therefore, the trained initial curve classification model is directly used as the curve classification model.

In this embodiment, the clustered target cluster set is used to determine the first training sample set, so as to determine the first training sample set in a quickly and accurately manner, and there is no need to manually determine the label class calibration value of the first training sample in the first training sample set, which reduces the cost of determining the first training sample set. In the existing method, the sample data of single-day grid supply load with the same or similar influencing factor daily characteristic data is clustered into the same cluster set, while the trend of the detection value of grid supply load at a single time point is not considered, which makes the trend of the detection values of grid supply load at the single time point in the same cluster set greatly different and affects the accuracy of the curve classification model obtained by training based on the cluster set. In order to solve this problem, in the present disclosure, each sample data of single-day grid supply load in the sample data set of the historical grid supply load is clustered, while it does not need to cluster each influencing factor daily characteristic data corresponding to the sample data set of the historical grid supply load, so that the clustering rule depends on the trend of the detection value of grid supply load at the single time point, and each sample data of single-day grid supply load in the target cluster set has the same or similar trends, thereby benefiting the improvement of the accuracy of the curve classification model that is trained using the first training sample set determined based on the target cluster set.

In one embodiment, the above-mentioned step (304) of obtaining the plurality of target cluster sets by clustering each sample data of single-day grid supply load in the sample data set of the historical grid supply load may include the following steps.

402: obtaining any of the sample data of single-day grid supply load from the sample data set of the historical grid supply load to take as a to-be-analyzed single-day data.

As an example, any of the sample data of single-day grid supply load may be obtained from the sample data set of the historical grid supply load, and the obtained sample data of single-day grid supply load may be used as the to-be-analyzed single-day data.

404: obtaining an average value of single-day grid supply load by performing an average calculation on a detection value of grid supply load of each single time point in the to-be-analyzed single-day data.

As an example, the average calculation may be performed on the detection value of grid supply load of each single time point in the to-be-analyzed single-day data, and the calculated average value may be used as the average value of single-day grid supply load.

406: obtaining per-unit data of each single time point by dividing the detection value of grid supply load of the single time point in the to-be-analyzed single-day data by the average value of single-day grid supply load.

As an example, the detection value of grid supply load of a certain single time point in the to-be-analyzed single-day data is divided by the average value of single-day grid supply load, and each calculated data may be used as per-unit data of the single time point.

408: taking each of the per-unit data of the single time point as a per-unit data of single-day grid supply load corresponding to the to-be-analyzed single-day data.

As an example, each the per-unit data of a single time point may be sorted in order by time point, and the sorted per-unit data of the single time point may be used as the per-unit data of the single-day grid supply load corresponding to the to-be-analyzed single-day data. That is, the per-unit data of single-day grid supply load corresponding to the to-be-analyzed single-day data is sequence data sorted by time point.

410: obtaining a plurality of initial target cluster sets by clustering each of the per-unit data of single-day grid supply load.

As an example, a preset clustering algorithm is used to cluster each per-unit data of a single-day grid supply load, and each set obtained by the clustering is used as one initial target cluster set.

412: taking each of the sample data of single-day grid supply load corresponding to each of the initial target cluster sets as one of the target cluster sets.

As a an example, each of the sample data of single-day grid supply load corresponding to each of the initial target cluster sets may be taken as one of the target cluster sets may be used as one target cluster set, thereby realizing the clustering of the sample data of single-day grid supply load.

In this embodiment, the sample data of a single-day grid supply load is clustered after the per-unitization, thereby realizing the clustering based on per-unit load curve data, which improves the accuracy of clustering.

In one embodiment, the above-mentioned step (306) of generating the first training sample set base on each of the target cluster sets and an influencing factor daily characteristic data sample set corresponding to the sample data set of the historical grid supply load may include the following steps.

502: taking any one of the target cluster sets as a to-be-analyzed cluster set.

504: obtaining one of the sample data of single-day grid supply load from the to-be-analyzed cluster set to take as a to-be-analyzed sample data.

As an example, any one of the sample data of single-day grid supply load may be obtained from the to-be-analyzed cluster set to take as the to-be-analyzed sample data.

506: obtaining a first sample data by extracting an average value of grid supply load, a peak value of grid supply load, and a valley value of grid supply load from the to-be-analyzed sample data.

As an example, the average value, the peak value, and the valley value may be extracted from each detection value of a grid supply load at a single time point in the to-be-analyzed sample data. The extracted average value may be used as the average value of the grid supply load corresponding to the to-be-analyzed sample data, the extracted peak value may be used as the peak value of the grid supply load corresponding to the to-be-analyzed sample data, and the extracted valley value may be used as the valley value of the grid supply load corresponding to the to-be-analyzed sample data. The average value of the grid supply load, the peak value of the grid supply load, and the valley value of the grid supply load that correspond to the to-be-analyzed sample data may be used as the first sample data.

508: obtaining an influencing factor daily characteristic data sample from the influencing factor daily characteristic data sample set based on the to-be-analyzed sample data to take as second sample data.

As an example, the influencing factor daily characteristic data sample may be obtained from the influencing factor daily characteristic data sample set based on the detection date in the to-be-analyzed sample data, and the obtained influencing factor daily characteristic data sample may be taken as the second sample data.

In one embodiment, the influencing factor daily characteristic data sample may be obtained from the influencing factor daily characteristic data sample set based on the detection date in the to-be-analyzed sample data, the daily comprehensive characteristic of each factor feature in the influencing factor daily characteristic data sample may be extracted by day, and each extracted daily comprehensive characteristic may be taken as the second sample data.

510: taking the first sample data and the second sample data as single-day sample data of a first training sample corresponding to the to-be-analyzed sample data;

As an example, the first sample data and the second sample data may be taken as the single-day sample data of the first training sample corresponding to the to-be-analyzed sample data, thereby realizing the automatic determination of the single-day sample data of the first training sample.

512: obtaining a class calibration value of the first training sample corresponding to the to-be-analyzed sample data by setting a value of a vector element in a preset label vector template corresponding to the to-be-analyzed cluster set to 1, where each vector element in the label vector template corresponds to each of the target cluster set, and an initial value of each vector element in the label vector template is 0.

As an example, the initial value of each vector element in the preset label vector template may be 0. Therefore, the value of the vector element corresponding to the to-be-analyzed cluster set in the preset label vector template may be set to 1, so as to determine the class calibration value of the first training sample in an automatically manner.

It can be understood that by repeating steps 502 and 512, the first training sample corresponding to each sample data of single-day grid supply load in the sample data set of the historical grid supply load can be determined.

514: taking each of the first training samples as the first training sample set.

As an example, each of the first training samples may be directly used as the first training sample set.

In this embodiment, it realizes using the average value of grid supply load, the peak value of grid supply load, the valley value of grid supply load, and the influencing factor daily characteristic data sample in the influencing factor daily characteristic data sample set as the single-day sample data of the first training sample, and determining the class calibration value of the first training sample according to the label vector template and the target cluster set, so as to determine the training samples based on clustering in an automatic manner while there is no need to manually determine the label class calibration value of the first training sample in the first training sample set, and therefore reduces the cost of determining the first training sample set.

In one embodiment, before the step (108) of obtaining the grid supply load prediction model corresponding to the grid supply load curve type to take as the target prediction model, the method may further include the following steps.

602: obtaining an initial prediction model of grid supply load and a second training sample set corresponding to the grid supply load curve type.

The second training sample set may include a plurality of second training samples.

As an example, the initial prediction model of grid supply load and the second training sample set corresponding to the grid supply load curve type that is input by the user may be obtained. The initial prediction model of grid supply load and the second training sample set corresponding to the grid supply load curve type may be obtained from a database or a third-party application.

The initial prediction model of grid supply load may be a model obtained based on a Temporal Convolutional Network (TCN).

604: obtaining a to-be-verified model by using the second training sample set to train the initial prediction model of grid supply load.

The step for obtaining the to-be-verified model by using the second training sample set to train the initial prediction model of grid supply load will not be repeated herein.

The second training sample set is used to train the initial prediction model of grid supply load until the loss value of the initial prediction model of grid supply load converges to a preset second value. When the loss value of the initial prediction model of grid supply load converges to the preset second value, it means that the training of the initial model of grid supply load prediction is completed, and the initial prediction model of grid supply load at this time is used as the to-be-verified model.

606: obtaining a model verification result by verifying the to-be-verified model based on a preset evaluation index set and a test sample set corresponding to the grid supply load curve type.

The test sample set includes a plurality of test samples.

As an example, the test sample set corresponding to the grid supply load curve type may be input into the to-be-verified model for prediction. If the prediction result meets the evaluation requirements of the preset evaluation index set, the model verification result may be determined to be succeeded; otherwise, the model verification result may be determined to be failed.

608: taking the to-be-verified model as the initial prediction model of grid supply load, and returning to the obtaining the to-be-verified model by using the second training sample set to train the initial prediction model of grid supply load, in response to the model verification result being failed;

As an example, if the model verification result is failed, it means that the to-be-verified model does not meet the verification requirements. Therefore, the to-be-verified model may be used as the initial prediction model of grid supply load to provide a basis for the next training. The step of returning to the obtaining the to-be-verified model by using the second training sample set to train the initial prediction model of grid supply load, in response to the model verification result being failed is to repeat steps 604-608.

610: taking the to-be-verified model as the grid supply load prediction model corresponding to the grid supply load curve type, in response to the model verification result being succeeded.

As an example, if the model verification result is successful, it means that the to-be-verified model meets the verification requirements. Therefore, the to-be-verified model may be used as the grid supply load prediction model corresponding to the grid supply load curve type.

In this embodiment, the initial prediction model of grid supply load is trained using the second training sample set corresponding to the grid supply load curve type, so as to determine the grid supply load prediction model corresponding to the grid supply load curve type, so that the prediction accuracy of the grid supply load prediction model corresponding to the grid supply load curve type can be improved when predicting the data corresponding to the grid supply load curve type. The to-be-verified model is verified through the preset evaluation index set, so that the grid supply load prediction model corresponding to the grid supply load curve type meets the evaluation requirements of the preset evaluation index set, thereby improving the prediction accuracy of the grid supply load prediction model corresponding to the grid supply load curve type.

In one embodiment, the above-mentioned evaluation index set may include mean absolute error index, mean absolute percentage error index and root mean square error index.

In which, the mean absolute error index may include an evaluation range of a mean absolute error. The mean absolute percentage error index may include an evaluation range of a mean absolute percentage error. The root mean square error index may include an evaluation range of a root mean square error.

The step (606) of obtaining the model verification result by verifying the to-be-verified model based on the preset evaluation index set and the test sample set corresponding to the grid supply load curve type may include the following steps.

702: obtaining single-sample target grid supply load prediction results by inputting sample data of each test sample in the test sample set corresponding to the grid supply load curve type into the to-be-verified model for grid supply load prediction.

As an example, the sample data of each test sample in the test sample set corresponding to the grid supply load curve type may be input into the to-be-verified model for grid supply load prediction, and each predicted data may be used as one single-sample target grid supply load prediction result.

704: obtaining a first verification result by sampling the average absolute error index, each of the single-sample target grid supply load prediction results, and the test sample set corresponding to the grid supply load curve type to verify the to-be-verified model.

As an example, a target mean absolute error may be obtained by performing a mean absolute error calculation on the to-be-verified model based on each of the single-sample target grid supply load prediction results and each calibration data of each test sample in the test sample set corresponding to the grid supply load curve type. It determines whether the target mean absolute error is within the evaluation range of the mean absolute error index. If so, the first verification result may be determined to be successful; otherwise, the first verification result may be determined to be failed.

706: obtaining a second verification result by sampling the average absolute percentage error index, each of the single-sample target grid supply load prediction results, and the test sample set corresponding to the grid supply load curve type to verify the to-be-verified model.

As an example, a target average absolute percentage error may be obtained by performing an average absolute percentage error calculation on the to-be-verified model based on each of the single-sample target grid supply load prediction results and each calibration data of each test sample in the test sample set corresponding to the grid supply load curve type. It determines whether the target average absolute percentage error is within the evaluation range of the average absolute percentage error index. If so, the second verification result may be determined to be successful; otherwise, the second verification result may be determined to be failed.

708: obtaining a third verification result by sampling the root mean square error index, each of the single-sample target grid supply load prediction results, and the test sample set corresponding to the grid supply load curve type to verify the to-be-verified model;

As an example, a target root mean square error may be obtained by performing a root mean square error calculation on the to-be-verified model based on each of the single-sample target grid supply load prediction results and each calibration data of each test sample in the test sample set corresponding to the grid supply load curve type. It determines whether the target average absolute error is within the evaluation range of the root mean square error index. If so, the third verification result may be determined to be successful; otherwise, the third verification result may be determined to be failed.

710: defining the model verification result as succeeded in response to the first verification result, the second verification result, and the third verification result being all succeeded; otherwise, defining the model verification result as failed.

As an example, if the first verification result, the second verification result and the third verification result are all successful, it may determine that the model verification result is successful; otherwise, if any of the first verification result, the second verification result, and the third verification result is failed, it may determine that the model verification result is failed.

In this embodiment, the model verification result is determined to be successful when the first verification result, the second verification result and the third verification result are all successful, so that the to-be-verified model that meets the average absolute error index, the average absolute percentage error index and the root mean square error index is used as the grid supply load prediction model corresponding to the grid supply load curve type.

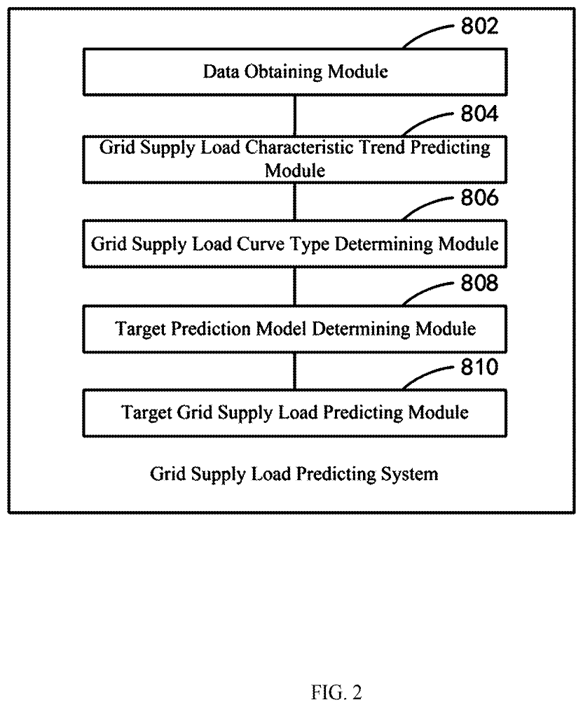

FIG. 2 is a schematic block diagram of the structure of a grid supply load predicting system according to an embodiment of the present disclosure. As shown in FIG. 2, in one embodiment, a grid supply load predicting system for a target electrical grid is provided. The system may be a terminal device or a server including a processor, a memory coupled to the processor, at least a computer program stored in the memory and executable on the processor, where the computer program may include:
a data obtaining module 802 configured to obtain a target prediction day and a historical data set of a grid supply load of the target electrical grid and daily characteristic data of target influencing factor corresponding to the target prediction day, and determine a characteristic data set of a historical grid supply load based on the historical data set of the grid supply load;
a grid supply load characteristic trend predicting module 804 configured to obtain a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
a grid supply load curve type determining module 806 configured to determine a grid supply load curve type corresponding to the target prediction day based on the grid supply load characteristic trend prediction result and the daily characteristic data of target influencing factor;
a target prediction model determining module 808 configured to obtain a grid supply load prediction model corresponding to the grid supply load curve type to take as a target prediction model; and
a target grid supply load predicting module 810 configured to obtain a target grid supply load prediction result corresponding to the target prediction day by inputting the historical data set of the grid supply load, the grid supply load characteristic trend prediction result and the daily characteristic data of target influencing factor into the target prediction model for grid supply load prediction.

In this embodiment, it realizes the extraction of characteristic indexes and the optimization of the original data set using multiple prediction algorithms by predicting the grid supply load characteristic trend, determining the grid supply load curve type, and predicting the grid supply load based on the characteristic data set of the historical grid supply load and the daily characteristic data of target influencing factor, and further realizes the prediction of grid supply load based on the integration of the prediction of the grid supply load characteristic trend, the determination of the grid supply load curve type, and the prediction of the grid supply load, according to the historical data set of the grid supply load, the grid supply load characteristic trend prediction result, the daily characteristic data of target influencing factor, and the grid supply load curve type. The coupling relationship between the power consumption and the power generation is fully explored, and the precision and the accuracy of the prediction of the grid supply load are effectively improved.

In one embodiment, the computer program may further include:
a model training module configured to obtain a sample data set of the historical grid supply load; obtain a plurality of target cluster sets by clustering each sample data of single-day grid supply load in the sample data set of the historical grid supply load; generate a first training sample set base on each of the target cluster sets and an influencing factor daily characteristic data sample set corresponding to the sample data set of the historical grid supply load; sample the first training sample set to train a preset initial curve classification model, and taking the trained initial curve classification model as the curve classification model.

In this embodiment, the clustered target cluster set is used to determine the first training sample set, so as to determine the first training sample set in a quickly and accurately manner, and there is no need to manually determine the label class calibration value of the first training sample in the first training sample set and therefore reduces the cost of determining the first training sample set. In the existing method, the sample data of single-day grid supply load with the same or similar influencing factor daily characteristic data is clustered into the same cluster set, while the trend of the detection value of grid supply load at a single time point is not considered and therefore makes the trend of the detection values of grid supply load at the single time point in the same cluster set greatly different and affects the accuracy of the curve classification model obtained by training based on the cluster set. In order to solve this problem, in the present disclosure, each sample data of single-day grid supply load in the sample data set of the historical grid supply load is clustered, while it does not need to cluster each influencing factor daily characteristic data corresponding to the sample data set of the historical grid supply load, so that the clustering rule depends on the trend of the detection value of grid supply load at the single time point, and each sample data of single-day grid supply load in the target cluster set has the same or similar trends, thereby benefiting the improvement of the accuracy of the curve classification model that is trained using the first training sample set determined based on the target cluster set.

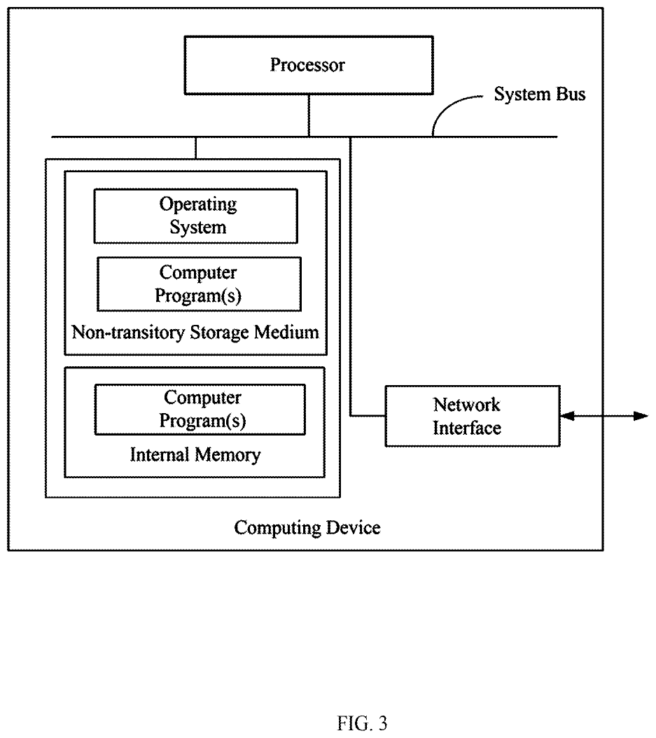

FIG. 3 is a schematic block diagram of the structure of a computing device according to an embodiment of the present disclosure. The computing device may be a terminal device or a server. As shown in FIG. 3, the computing device may include a processor, storage and a network interface that are connected by a system bus. In which, the storage may include a non-transitory storage medium and an internal memory. The non-transitory storage medium of the computing device stores an operating system, and may further store at least a computer program so that when the computer program is executed by the processor, the processor can be made to realize the above-mentioned grid supply load predicting method. The internal memory may also store with computer program so that when the computer program is executed by the processor, the processor can be made to perform the above-mentioned grid supply load predicting method. Those skilled in the art can understand that the structure shown in FIG. 3 is only a block diagram of a partial structure related to the scheme of the present disclosure, and does not constitute a limitation on the computing device to which the scheme of the present disclosure is applied. The real computing device may include more or fewer components than shown in the figures, and may also combine certain components or have a different arrangement of components.

In one embodiment, the computing device including storage and a processor is provided. The storage stores at least a computer program. When the computer program is executed by a processor, the processor is made to perform the following steps:
obtaining a target prediction day and a historical data set of a grid supply load of a target electrical grid and daily characteristic data of target influencing factor corresponding to the target prediction day, and determining a characteristic data set of a historical grid supply load based on the historical data set of the grid supply load;
obtaining a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
determining a grid supply load curve type corresponding to the target prediction day based on the grid supply load characteristic trend prediction result and the daily characteristic data of target influencing factor;
obtaining a grid supply load prediction model corresponding to the grid supply load curve type to take as a target prediction model; and
obtaining a target grid supply load prediction result that corresponds to the target prediction day by inputting the historical data set of the grid supply load, the grid supply load characteristic trend prediction result and the daily characteristic data of target influencing factor into the target prediction model for grid supply load prediction.

In this embodiment, it realizes the extraction of characteristic indexes and the optimization of the original data set using multiple prediction algorithms by predicting the grid supply load characteristic trend, determining the grid supply load curve type, and predicting the grid supply load based on the characteristic data set of the historical grid supply load and the daily characteristic data of target influencing factor, and further realizes the prediction of grid supply load based on the integration of the prediction of the grid supply load characteristic trend, the determination of the grid supply load curve type, and the prediction of the grid supply load, according to the historical data set of the grid supply load, the grid supply load characteristic trend prediction result, the daily characteristic data of target influencing factor, and the grid supply load curve type. The coupling relationship between the power consumption and the power generation is fully explored, and the precision and the accuracy of the prediction of the grid supply load are effectively improved.

In one embodiment, a non-transitory computer-readable storage medium storing at least a computer program is provided. When the computer program is executed by a processor, the processor is made to perform the following steps:
obtaining a target prediction day and a historical data set of a grid supply load of a target electrical grid and daily characteristic data of target influencing factor corresponding to the target prediction day, and determining a characteristic data set of a historical grid supply load based on the historical data set of the grid supply load;
obtaining a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
determining a grid supply load curve type corresponding to the target prediction day based on the grid supply load characteristic trend prediction result and the daily characteristic data of target influencing factor;
obtaining a grid supply load prediction model corresponding to the grid supply load curve type to take as a target prediction model; and
obtaining a target grid supply load prediction result that corresponds to the target prediction day by inputting the historical data set of the grid supply load, the grid supply load characteristic trend prediction result and the daily characteristic data of target influencing factor into the target prediction model for grid supply load prediction.

In this embodiment, it realizes the extraction of characteristic indexes and the optimization of the original data set using multiple prediction algorithms by predicting the grid supply load characteristic trend, determining the grid supply load curve type, and predicting the grid supply load based on the characteristic data set of the historical grid supply load and the daily characteristic data of target influencing factor, and further realizes the prediction of grid supply load based on the integration of the prediction of the grid supply load characteristic trend, the determination of the grid supply load curve type, and the prediction of the grid supply load, according to the historical data set of the grid supply load, the grid supply load characteristic trend prediction result, the daily characteristic data of target influencing factor, and the grid supply load curve type. The coupling relationship between the power consumption and the power generation is fully explored, and the precision and the accuracy of the prediction of the grid supply load are effectively improved.

Those of ordinary skill in the art can understand that all or part of the processes in the methods of the foregoing embodiments can be implemented by instructing relevant hardware through a computer program. The program can be stored in a non-transitory computer-readable storage medium. When the program is executed, it may include performing the process of the foregoing method embodiments. In which, any reference to memory, storage, database or other medium used in the various embodiments provided in the present disclosure may include non-transitory and/or transitory memory. The non-transitory memory may include a read-only memory (ROM), programmable ROM (PROM), an electrically programmable ROM (EPROM), an electrically erasable programmable ROM (EEPROM), or a flash memory. The transitory memory may include a random access memory (RAM) or an external cache memory. By way of illustration but not limitation, RAM may be in various forms such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), rambus direct RAM (RDRAM), direct rambus dynamic RAM (DRDRAM), and rambus dynamic RAM (RDRAM).

The technical features of the foregoing embodiments may be combined arbitrarily. To make the description simple, not all possible combinations of the technical features in the above embodiments are described. However, as long as there is no contradiction in the combination of these technical features, the combination will be considered to be within the scope described in this specification.

The foregoing embodiments only represent several embodiments of the present disclosure, and the descriptions thereof are relatively specific and detailed, but should not be construed as limitations on the scope of the present disclosure. It should be pointed out that, for those skilled in the art, several modifications and improvements can be made without departing from the concept of the present disclosure, and these modifications and improvements are all within the scope of the present disclosure. Therefore, the scope of the present disclosure shall be subject to the appended claims.

What is claimed is:

1. A computer-implemented grid supply load predicting method for a target electrical grid, comprising:
obtaining a target prediction day and a historical data set of a grid supply load of the target electrical grid and daily characteristic data of target influencing factor corresponding to the target prediction day, and determining a characteristic data set of a historical grid supply load based on the historical data set of the grid supply load;
obtaining a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
determining a grid supply load curve type corresponding to the target prediction day based on the grid supply load characteristic trend prediction result and the daily characteristic data of target influencing factor;
obtaining a grid supply load prediction model corresponding to the grid supply load curve type to take as a target prediction model; and
obtaining a target grid supply load prediction result of the target electrical grid that corresponds to the target prediction day by inputting the historical data set of the grid supply load, the grid supply load characteristic trend prediction result and the daily characteristic data of target influencing factor into the target prediction model for grid supply load prediction.

2. The method of claim 1, wherein the determining the grid supply load curve type corresponding to the target prediction day based on the grid supply load characteristic trend prediction result and the daily characteristic data of target influencing factor comprises:
obtaining the grid supply load curve type corresponding to the target prediction day by inputting the grid supply load characteristic trend prediction result and the daily characteristic data of target influencing factor into a preset curve classification model for classification prediction of a grid supply load daily curve.

3. The method of claim 2, wherein before obtaining the grid supply load curve type corresponding to the target prediction day by inputting the grid supply load characteristic trend prediction result and the daily characteristic data of target influencing factor into the preset curve classification model for classification prediction of the grid supply load daily curve, the method further comprises:
obtaining a sample data set of the historical grid supply load;
obtaining a plurality of target cluster sets by clustering each sample data of single-day grid supply load in the sample data set of the historical grid supply load;
generating a first training sample set base on each of the target cluster sets and an influencing factor daily characteristic data sample set corresponding to the sample data set of the historical grid supply load; and
sampling the first training sample set to train a preset initial curve classification model, and taking the trained initial curve classification model as the curve classification model.

4. The method of claim 3, wherein the obtaining the plurality of target cluster sets by clustering each sample data of single-day grid supply load in the sample data set of the historical grid supply load comprises:
obtaining any of the sample data of single-day grid supply load from the sample data set of the historical grid supply load to take as a to-be-analyzed single-day data;
obtaining an average value of single-day grid supply load by performing an average calculation on a detection value of grid supply load of each single time point in the to-be-analyzed single-day data;
obtaining per-unit data of each single time point by dividing the detection value of grid supply load of the single time point in the to-be-analyzed single-day data by the average value of single-day grid supply load;
taking each of the per-unit data of the single time point as a per-unit data of single-day grid supply load corresponding to the to-be-analyzed single-day data;
obtaining a plurality of initial target cluster sets by clustering each of the per-unit data of single-day grid supply load; and
taking each of the sample data of single-day grid supply load corresponding to each of the initial target cluster sets as one of the target cluster sets.

5. The method of claim 3, wherein the generating the first training sample set base on each of the target cluster sets and the influencing factor daily characteristic data sample set corresponding to the sample data set of the historical grid supply load comprises:
taking any one of the target cluster sets as a to-be-analyzed cluster set;
obtaining one of the sample data of single-day grid supply load from the to-be-analyzed cluster set to take as a to-be-analyzed sample data;
obtaining a first sample data by extracting an average value of grid supply load, a peak value of grid supply load, and a valley value of grid supply load from the to-be-analyzed sample data;
obtaining an influencing factor daily characteristic data sample from the influencing factor daily characteristic data sample set based on the to-be-analyzed sample data to take as second sample data;
taking the first sample data and the second sample data as single-day sample data of a first training sample corresponding to the to-be-analyzed sample data;
obtaining a class calibration value of the first training sample corresponding to the to-be-analyzed sample data by setting a value of a vector element in a preset label vector template corresponding to the to-be-analyzed cluster set to 1, wherein each vector element in the label vector template corresponds to each of the target cluster set, and an initial value of each vector element in the label vector template is 0; and
taking each of the first training samples as the first training sample set.

6. The method of claim 1, wherein before obtaining the grid supply load prediction model corresponding to the grid supply load curve type to take as the target prediction model, the method further comprises:
obtaining an initial prediction model of grid supply load and a second training sample set corresponding to the grid supply load curve type;
obtaining a to-be-verified model by using the second training sample set to train the initial prediction model of grid supply load;
obtaining a model verification result by verifying the to-be-verified model based on a preset evaluation index set and a test sample set corresponding to the grid supply load curve type;
taking the to-be-verified model as the initial prediction model of grid supply load, and returning to the obtaining the to-be-verified model by using the second training sample set to train the initial prediction model of grid supply load, in response to the model verification result being failed; and
taking the to-be-verified model as the grid supply load prediction model corresponding to the grid supply load curve type, in response to the model verification result being succeeded.

7. The method of claim 6, wherein the evaluation index set includes mean absolute error index, mean absolute percentage error index and root mean square error index, and the obtaining the model verification result by verifying the to-be-verified model based on the preset evaluation index set and the test sample set corresponding to the grid supply load curve type comprises:
obtaining a single-sample target grid supply load prediction result by inputting sample data of each test sample in the test sample set corresponding to the grid supply load curve type into the to-be-verified model for grid supply load prediction;
obtaining a first verification result by sampling the average absolute error index, each of the single-sample target grid supply load prediction results, and the test sample set corresponding to the grid supply load curve type to verify the to-be-verified model;
obtaining a second verification result by sampling the average absolute percentage error index, each of the single-sample target grid supply load prediction results, and the test sample set corresponding to the grid supply load curve type to verify the to-be-verified model;
obtaining a third verification result by sampling the root mean square error index, each of the single-sample target grid supply load prediction results, and the test sample set corresponding to the grid supply load curve type to verify the to-be-verified model; and
defining the model verification result as succeeded in response to the first verification result, the second verification result; and defining the model verification result as failed in response to any of the first verification result, the second verification result, and the third verification result being succeeded.

8. A grid supply load predicting system for a target electrical grid, comprising:
a processor;
a memory coupled to the processor; and
one or more computer programs stored in the memory and executable on the processor;
wherein, the one or more computer programs comprise:
instructions for obtaining a target prediction day and a historical data set of a grid supply load of the target electrical grid and daily characteristic data of target influencing factor corresponding to the target prediction day, and determine a characteristic data set of a historical grid supply load based on the historical data set of the grid supply load;
instructions for obtaining a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
instructions for determining a grid supply load curve type corresponding to the target prediction day based on the grid supply load characteristic trend prediction result and the daily characteristic data of target influencing factor;
instructions for obtaining a grid supply load prediction model corresponding to the grid supply load curve type to take as a target prediction model; and
instructions for obtaining a target grid supply load prediction result of the target electrical grid that corresponds to the target prediction day by inputting the historical data set of the grid supply load, the grid supply load characteristic trend prediction result and the daily characteristic data of target influencing factor into the target prediction model for grid supply load prediction.

9. The system of claim 8, wherein the instructions for determining the grid supply load curve type corresponding to the target prediction day based on the grid supply load characteristic trend prediction result and the daily characteristic data of target influencing factor comprise:
instructions for obtaining the grid supply load curve type corresponding to the target prediction day by inputting the grid supply load characteristic trend prediction result and the daily characteristic data of target influencing factor into a preset curve classification model for classification prediction of a grid supply load daily curve.

10. The system of claim 9, wherein the one or more computer programs further comprise:
instructions for obtaining a sample data set of the historical grid supply load;
instructions for obtaining a plurality of target cluster sets by clustering each sample data of single-day grid supply load in the sample data set of the historical grid supply load;
instructions for generating a first training sample set base on each of the target cluster sets and an influencing factor daily characteristic data sample set corresponding to the sample data set of the historical grid supply load;
instructions for sampling the first training sample set to train a preset initial curve classification model, and taking the trained initial curve classification model as the curve classification model.

11. The system of claim 10, wherein the instructions for obtaining the plurality of target cluster sets by clustering each sample data of single-day grid supply load in the sample data set of the historical grid supply load comprise:
instructions for obtaining any of the sample data of single-day grid supply load from the sample data set of the historical grid supply load to take as a to-be-analyzed single-day data;
instructions for obtaining an average value of single-day grid supply load by performing an average calculation on a detection value of grid supply load of each single time point in the to-be-analyzed single-day data;
instructions for obtaining per-unit data of each single time point by dividing the detection value of grid supply load of the single time point in the to-be-analyzed single-day data by the average value of single-day grid supply load;
instructions for taking each of the per-unit data of the single time point as a per-unit data of single-day grid supply load corresponding to the to-be-analyzed single-day data;
instructions for obtaining a plurality of initial target cluster sets by clustering each of the per-unit data of single-day grid supply load; and
instructions for taking each of the sample data of single-day grid supply load corresponding to each of the initial target cluster sets as one of the target cluster sets.

12. The system of claim 10, wherein the instructions for generating the first training sample set base on each of the target cluster sets and the influencing factor daily characteristic data sample set corresponding to the sample data set of the historical grid supply load comprise:
instructions for taking any one of the target cluster sets as a to-be-analyzed cluster set;
instructions for obtaining one of the sample data of single-day grid supply load from the to-be-analyzed cluster set to take as a to-be-analyzed sample data;
instructions for obtaining a first sample data by extracting an average value of grid supply load, a peak value of grid supply load, and a valley value of grid supply load from the to-be-analyzed sample data;
instructions for obtaining an influencing factor daily characteristic data sample from the influencing factor daily characteristic data sample set based on the to-be-analyzed sample data to take as second sample data;
instructions for taking the first sample data and the second sample data as single-day sample data of a first training sample corresponding to the to-be-analyzed sample data;
instructions for obtaining a class calibration value of the first training sample corresponding to the to-be-analyzed sample data by setting a value of a vector element in a preset label vector template corresponding to the to-be-analyzed cluster set to 1, wherein each vector element in the label vector template corresponds to each of the target cluster set, and an initial value of each vector element in the label vector template is 0; and
instructions for taking each of the first training samples as the first training sample set.

13. The system of claim 8, wherein the one or more computer programs further comprise:
instructions for obtaining an initial prediction model of grid supply load and a second training sample set corresponding to the grid supply load curve type;
instructions for obtaining a to-be-verified model by using the second training sample set to train the initial prediction model of grid supply load;
instructions for obtaining a model verification result by verifying the to-be-verified model based on a preset evaluation index set and a test sample set corresponding to the grid supply load curve type;
instructions for taking the to-be-verified model as the initial prediction model of grid supply load, and returning to the obtaining the to-be-verified model by using the second training sample set to train the initial prediction model of grid supply load, in response to the model verification result being failed; and
instructions for taking the to-be-verified model as the grid supply load prediction model corresponding to the grid supply load curve type, in response to the model verification result being succeeded.

14. A non-transitory computer-readable storage medium for storing one or more computer programs, wherein the one or more computer programs comprise:
instructions for obtaining a target prediction day and a historical data set of a grid supply load of a target electrical grid and daily characteristic data of target influencing factor corresponding to the target prediction day, and determining a characteristic data set of a historical grid supply load based on the historical data set of the grid supply load;
instructions for obtaining a grid supply load characteristic trend prediction result corresponding to the target prediction day by inputting the characteristic data set of the historical grid supply load and the daily characteristic data of target influencing factor into a preset trend prediction model for grid supply load characteristic trend prediction;
instructions for determining a grid supply load curve type corresponding to the target prediction day based on the grid supply load characteristic trend prediction result and the daily characteristic data of target influencing factor;
instructions for obtaining a grid supply load prediction model corresponding to the grid supply load curve type to take as a target prediction model; and
instructions for obtaining a target grid supply load prediction result of the target electrical grid that corresponds to the target prediction day by inputting the historical data set of the grid supply load, the grid supply load characteristic trend prediction result and the daily characteristic data of target influencing factor into the target prediction model for grid supply load prediction.

15. The storage medium of claim 14, wherein the instructions for determining the grid supply load curve type corresponding to the target prediction day based on the grid supply load characteristic trend prediction result and the daily characteristic data of target influencing factor comprise:
instructions for obtaining the grid supply load curve type corresponding to the target prediction day by inputting the grid supply load characteristic trend prediction result and the daily characteristic data of target influencing factor into a preset curve classification model for classification prediction of a grid supply load daily curve.

16. The storage medium of claim 15, wherein the one or more computer programs further comprise:
instructions for obtaining a sample data set of the historical grid supply load;
instructions for obtaining a plurality of target cluster sets by clustering each sample data of single-day grid supply load in the sample data set of the historical grid supply load;
instructions for generating a first training sample set base on each of the target cluster sets and an influencing factor daily characteristic data sample set corresponding to the sample data set of the historical grid supply load;
instructions for sampling the first training sample set to train a preset initial curve classification model, and taking the trained initial curve classification model as the curve classification model.

17. The storage medium of claim 16, wherein the instructions for obtaining the plurality of target cluster sets by clustering each sample data of single-day grid supply load in the sample data set of the historical grid supply load comprise:
instructions for obtaining any of the sample data of single-day grid supply load from the sample data set of the historical grid supply load to take as a to-be-analyzed single-day data;
instructions for obtaining an average value of single-day grid supply load by performing an average calculation on a detection value of grid supply load of each single time point in the to-be-analyzed single-day data;
instructions for obtaining per-unit data of each single time point by dividing the detection value of grid supply load of the single time point in the to-be-analyzed single-day data by the average value of single-day grid supply load;
instructions for taking each of the per-unit data of the single time point as a per-unit data of single-day grid supply load corresponding to the to-be-analyzed single-day data;
instructions for obtaining a plurality of initial target cluster sets by clustering each of the per-unit data of single-day grid supply load; and
instructions for taking each of the sample data of single-day grid supply load corresponding to each of the initial target cluster sets as one of the target cluster sets.

18. The storage medium of claim 16, wherein the instructions for generating the first training sample set base on each of the target cluster sets and the influencing factor daily characteristic data sample set corresponding to the sample data set of the historical grid supply load comprise:
instructions for taking any one of the target cluster sets as a to-be-analyzed cluster set;
instructions for obtaining one of the sample data of single-day grid supply load from the to-be-analyzed cluster set to take as a to-be-analyzed sample data;
instructions for obtaining a first sample data by extracting an average value of grid supply load, a peak value of grid supply load, and a valley value of grid supply load from the to-be-analyzed sample data;
instructions for obtaining an influencing factor daily characteristic data sample from the influencing factor daily characteristic data sample set based on the to-be-analyzed sample data to take as second sample data;
instructions for taking the first sample data and the second sample data as single-day sample data of a first training sample corresponding to the to-be-analyzed sample data;
instructions for obtaining a class calibration value of the first training sample corresponding to the to-be-analyzed sample data by setting a value of a vector element in a preset label vector template corresponding to the to-be-analyzed cluster set to 1, wherein each vector element in the label vector template corresponds to each of the target cluster set, and an initial value of each vector element in the label vector template is 0; and
instructions for taking each of the first training samples as the first training sample set.

19. The storage medium of claim 14, wherein the one or more computer programs further comprise:
instructions for obtaining an initial prediction model of grid supply load and a second training sample set corresponding to the grid supply load curve type;
instructions for obtaining a to-be-verified model by using the second training sample set to train the initial prediction model of grid supply load;
instructions for obtaining a model verification result by verifying the to-be-verified model based on a preset evaluation index set and a test sample set corresponding to the grid supply load curve type;
instructions for taking the to-be-verified model as the initial prediction model of grid supply load, and returning to the obtaining the to-be-verified model by using the second training sample set to train the initial prediction model of grid supply load, in response to the model verification result being failed; and
instructions for taking the to-be-verified model as the grid supply load prediction model corresponding to the grid supply load curve type, in response to the model verification result being succeeded.

20. The storage medium of claim 19, wherein the evaluation index set includes mean absolute error index, mean absolute percentage error index and root mean square error index, and the instructions for obtaining the model verification result by verifying the to-be-verified model based on the preset evaluation index set and the test sample set corresponding to the grid supply load curve type comprise:
instructions for obtaining a single-sample target grid supply load prediction result by inputting sample data of each test sample in the test sample set corresponding to the grid supply load curve type into the to-be-verified model for grid supply load prediction;
instructions for obtaining a first verification result by sampling the average absolute error index, each of the single-sample target grid supply load prediction results, and the test sample set corresponding to the grid supply load curve type to verify the to-be-verified model;
instructions for obtaining a second verification result by sampling the average absolute percentage error index, each of the single-sample target grid supply load prediction results, and the test sample set corresponding to the grid supply load curve type to verify the to-be-verified model;
instructions for obtaining a third verification result by sampling the root mean square error index, each of the single-sample target grid supply load prediction results, and the test sample set corresponding to the grid supply load curve type to verify the to-be-verified model; and
instructions for defining the model verification result as succeeded in response to the first verification result, the second verification result, and the third verification result being all succeeded; and defining the model verification result as failed in response to any of the first verification result, the second verification result, and the third verification result being succeeded.
